(19) United States
(12) Patent Application Publication
(10) Pub. No.: US 2012/0318098 A1
(43) Pub. Date: Dec. 20, 2012

(54) Automobile pedals and pedal covers for brakes accelerators, and clutches

(76) Inventor: Dillon Bruno, Inglewood, CA (US)

(21) Appl. No.: 13/134,890

(22) Filed: Jun. 20, 2011

(51) Int. Cl. G05G 1/483; G05G 1/30

(52) U.S. Cl. 74/563; 74/560

(57) ABSTRACT

An Improved Traction Pedal includes a first surface, a second surface, and a plurality of traction studs. The plurality of traction studs is disposed upon the first surface. The traction studs are used to create a greater frictional resistance between the pedal and the user's foot.

### FIELD OF THE INVENTION

The present invention is in the area of automotive accessories, and more particularly pertains to an improved pedal for brakes, clutches, and accelerators, as well as covers for brakes, clutches and accelerators.

### BACKGROUND OF THE INVENTION

When it comes to driving an automobile, there are two primary points of contact through which a driver interfaces with the automobile: the steering wheel and the pedals. Through these points of contact, a user is able to drive the automobile. Whereas the steering wheel controls the direction to which the car is turning, the accelerator, brakes, and clutch all control the forward, reverse, acceleration, and deceleration of the car.

Since the pedals are so frequently used with the car, they are also the fastest to abrade and wear out over time. Many pedals are comprised of a synthetic rubber that can tear, grow thin, and rip over time. And in extreme cases, this wear and tear can lead to unsafe driving conditions.

Moreover, some pedals are comprised of a metallic material which can be slippery as a user places their feet over the pedal. This can also create an unsafe driving condition especially for users who wear various footwear with no tread or traction on the undersides of their shoes.

Therefore, what is clearly needed in the art is an apparatus which enables a user to gain more traction and frictional resistance between the point of contact between the pedal and a user's foot. This apparatus should also be resistant to corrosion, wear and tear, as well as other typical abrasions which inhere with typical driving conditions. In addition, the traction should provide heightened resistance under extreme braking conditions.

### SUMMARY OF THE INVENTION

It is an object of the present invention to provide an apparatus to be able to replace existing brake, clutch or accelerator pads. These pads will be made of a more robust material with increased surface traction.

It is an object of the present invention to provide an apparatus to be retrofitted over existing brake, clutch or accelerator pads by simply slipping them over the existing pads. This is accomplished through a set of elastic members which can wrap around the existing pedals and create a strong interference fit between the cover and the OEM pedal.

### BRIEF DESCRIPTION OF THE DRAWING FIGURES

FIG. 1 is a plan view of a preferred embodiment of the present invention.

FIG. 2 is a plan view of a preferred embodiment of the present invention.

FIG. 3 is a plan view of a preferred embodiment of the present invention.

FIG. 4 is a rear plan view of a preferred embodiment of the present invention.

FIG. 5 is a rear plan of a preferred embodiment of the present invention.

FIG. 6 is a side elevation view of a preferred embodiment of the present invention.

FIG. 7 is a rear plan view of a preferred embodiment of the present invention.

FIG. 8 is a perspective view of a preferred embodiment of the present invention.

FIG. 9 is a perspective view of a preferred embodiment of the present invention.

FIG. 10 is a perspective view of a preferred embodiment of the present invention.

FIG. 11 is a perspective view of a preferred embodiment of the present invention.

FIG. 12 is a plan view of a preferred embodiment of the present invention.

FIG. 13 is a plan view of a preferred embodiment of the present invention.

FIG. 14 is a plan view of a preferred embodiment of the present invention.

FIG. 15 is a plan view of a preferred embodiment of the present invention.

FIG. 16 is a plan view of a preferred embodiment of the present invention.

FIG. 17 is a side elevation view of a preferred embodiment of the present invention.

FIG. 18 is a side elevation view of a preferred embodiment of the present invention.

FIG. 19 is a side elevation view of a preferred embodiment of the present invention.

FIG. 20 is a plan view of a preferred embodiment of the present invention.

FIG. 21 is a plan view of a preferred embodiment of the present invention.

FIG. 22 is a plan view of a preferred embodiment of the present invention.

FIG. 23 is a side elevation view of a preferred embodiment of the present invention.

FIG. 24 is a plan view of a preferred embodiment of the present invention.

FIG. 25 is a side elevation view of a preferred embodiment of the present invention.

FIG. 26 is a plan view of a preferred embodiment of the present invention.

FIG. 27 is a plan view of a preferred embodiment of the present invention.

### DESCRIPTION OF PREFERRED EMBODIMENTS

According to a preferred embodiment of the present invention, a unique pedal for brakes, clutches, or accelerators is used to provide users with heightened traction between their shoes and the pedal. The Pedals are also used to lengthen the life of the pad and can be used in extreme braking conditions. Moreover, the present invention can also be used to retrofit pre-existing pedals by simply slipping a pedal cover over the pedal. The present invention is described in enabling detail below.

For the purposes of the present invention, the term “traction studs” shall refer to physical structures to create greater frictional resistance between a user and the pedal. These traction studs can come in the form of various teeth, studs, or similar physical structures to create the desired effect of greater traction.

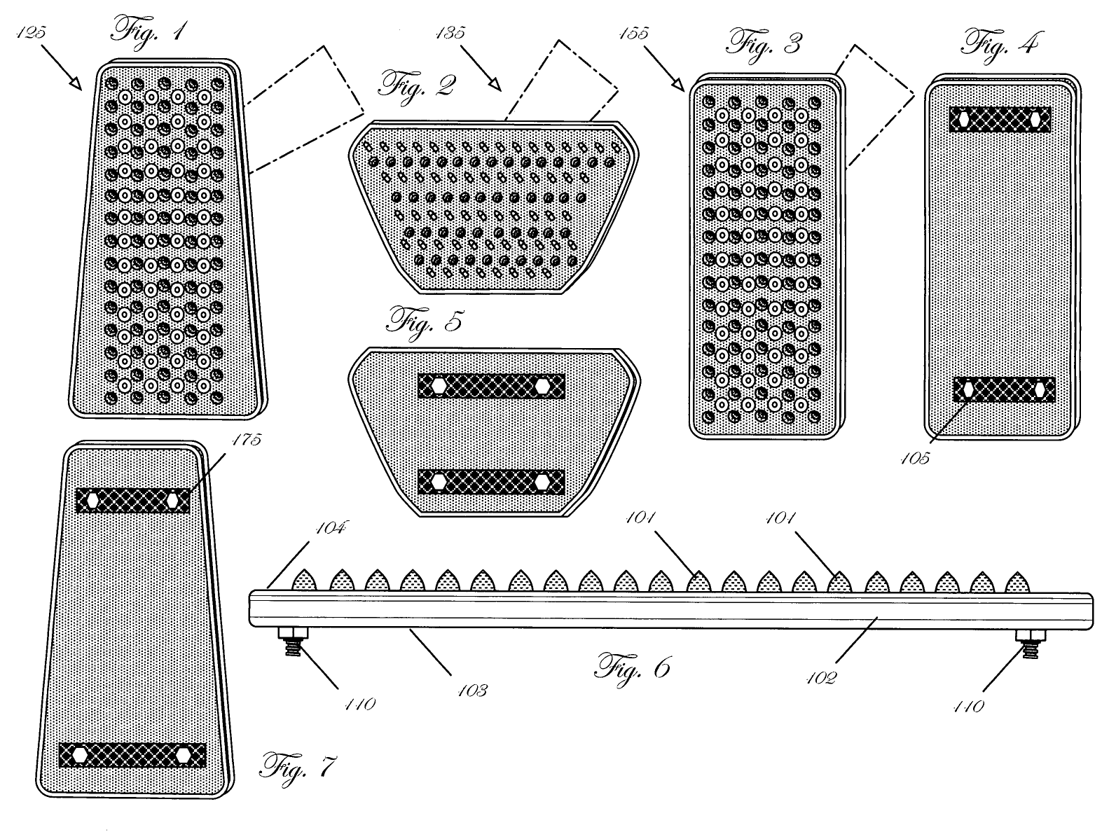

FIGS. 1-12 illustrate preferred embodiments of the present invention. An Improved Traction Pedal 100 includes a first surface 104, a second surface 103, and a plurality of traction studs 101. The plurality of traction studs is disposed upon the first surface. The traction studs are used to create a greater frictional resistance between the pedal and the user's foot.

It should be noted here, that the present invention may come in a variety of shapes. Most notably, these shapes may approximate the typical sizes and shapes of various gas or accelerator pedals, brake pedals, and clutches as illustrated in FIGS. 1-3.

In some preferred embodiments, the Improved Traction Pedal may further include a plurality of channels 200 as illustrated in FIG. 12. These channels are essentially grooves, which can roughly mate with outer tread of the shoes of a user. These channels are interspersed between the rows of traction studs. FIG. 13 illustrates that these channels can be arranged or disposed in a horizontal position as well.

In some preferred embodiments, these channels can be orifices bored longitudinally through the pedal. They may be arranged in the vertical or in the horizontal position. These bored channels can also be used to enable for hooking with an additional member as described below as well. These bored channels can also increase the strength and durability in the same way in which expansion members are added to bridges in order to better deal with warmer and colder temperatures as well.

The present invention may also be adapted for use in retrofitting existing pedals. In this preferred embodiment, a pedal cover is used to simply slip over the existing OEM (original equipment manufacturer) pedal. This fitting is accomplished through an elastic member 105 disposed on the bottom surface of the pedal cover. The elastic member may be affixed to the pedal cover in some preferred embodiments through screws.

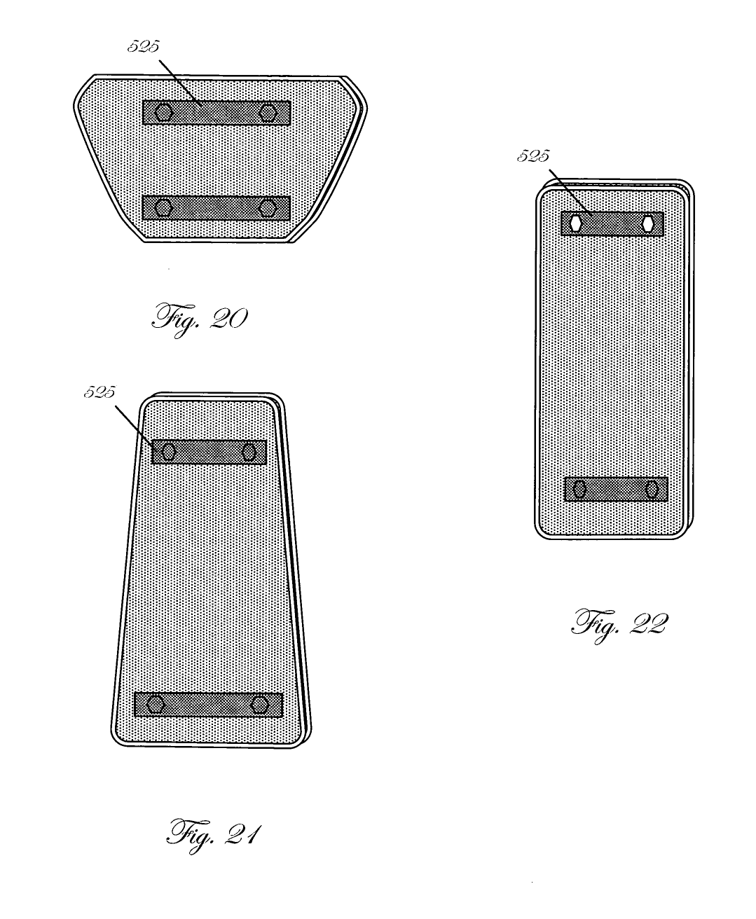

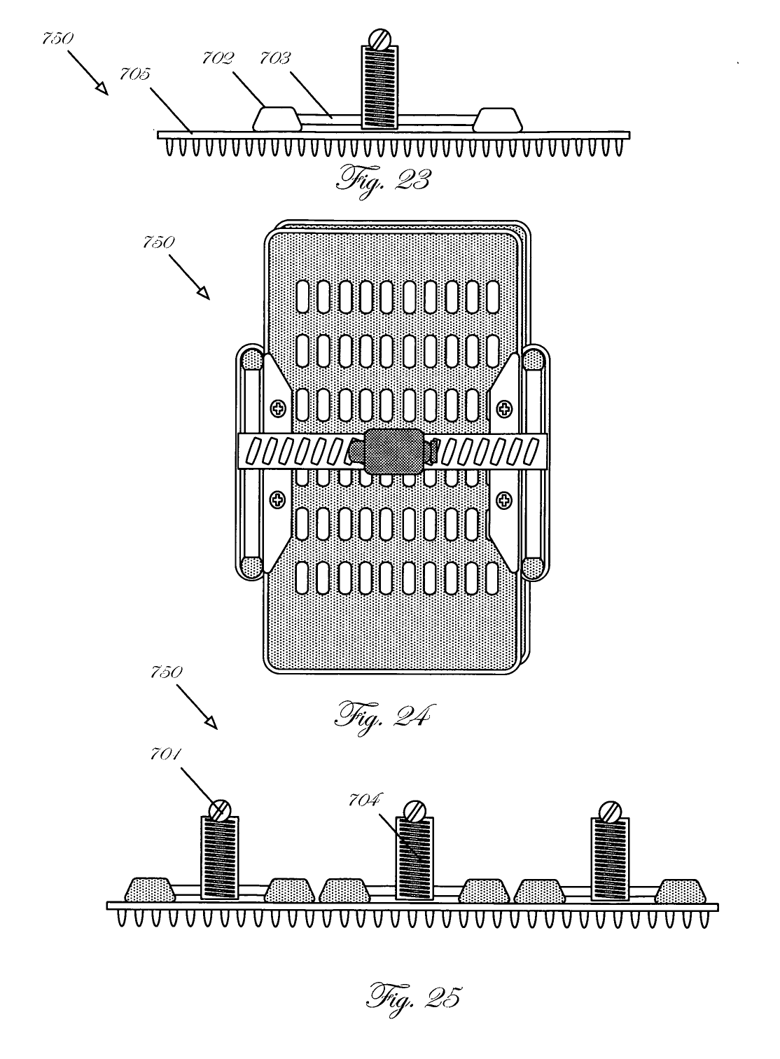

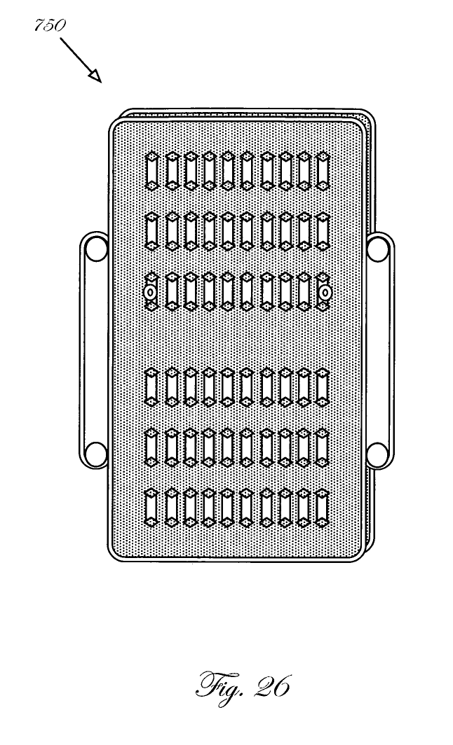

FIGS. 20-22 illustrate that in some preferred embodiments, the elastic member may be replaced with a simple metal bar 525. This metal bar is used to affix the Improved Traction Pedal 100 with the pedal.

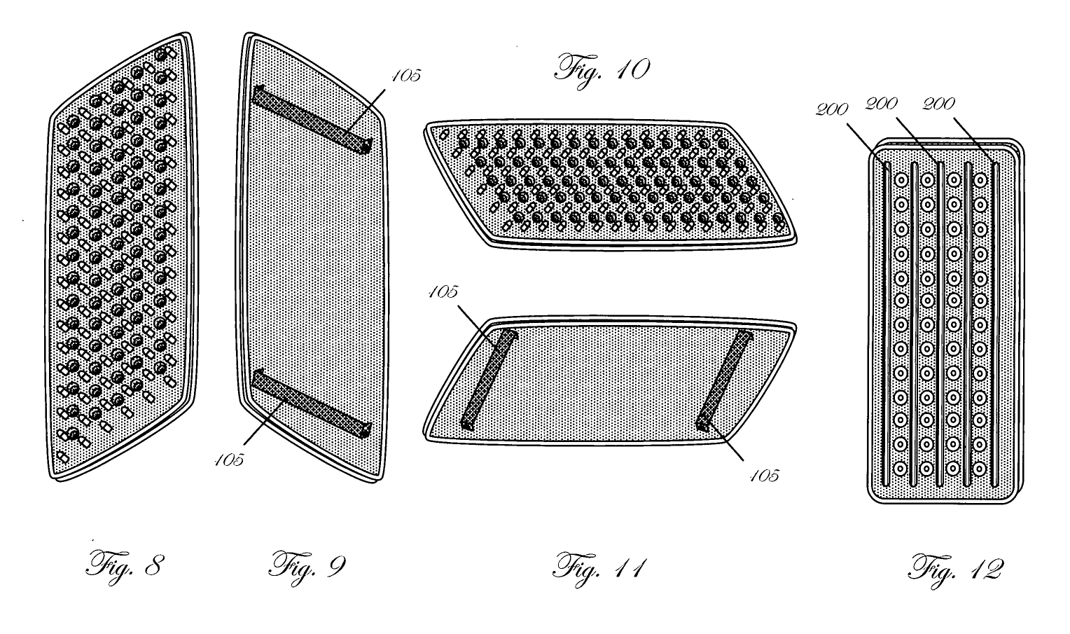

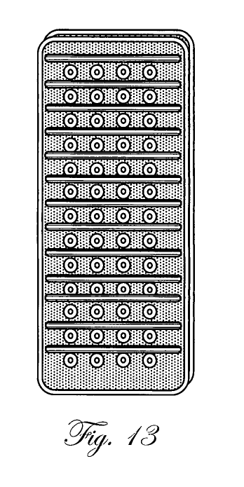

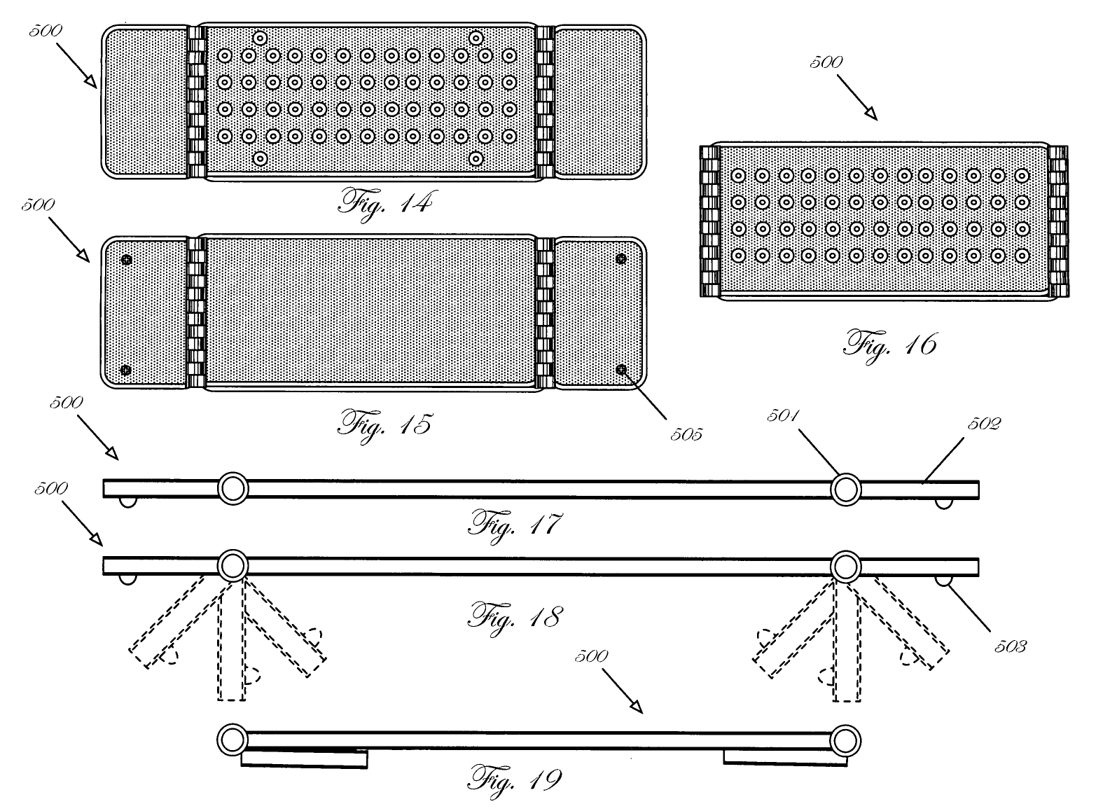

FIGS. 14-19 illustrate a clam shell cover 500. With this preferred embodiment, a set of hinged wings 502 flip over and snap onto the pedal. This fastening is created between the fastening member 503 and the fastening orifice 505.

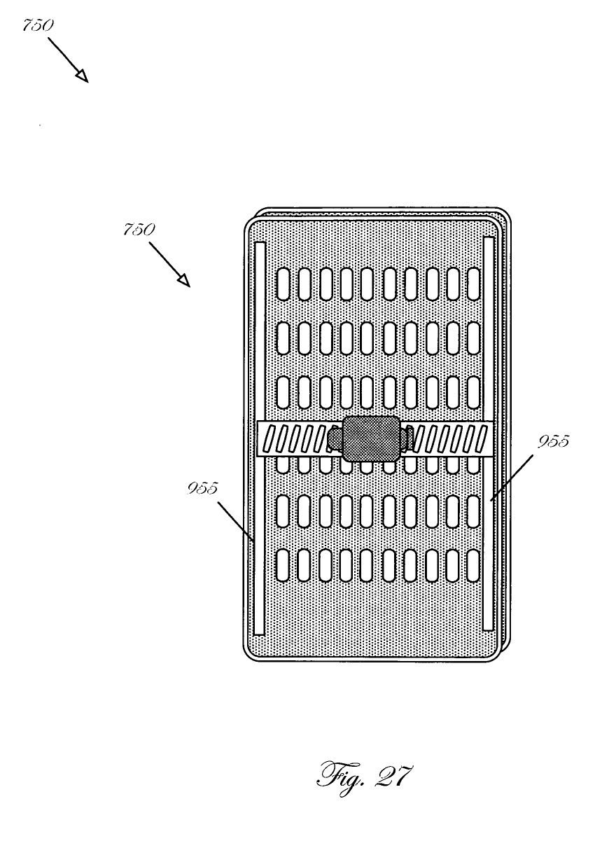

FIGS. 23-26 illustrate an Adjustable Pedal Pad 750. The Adjustable Pedal Pad 750 is enabled to wrap around another pedal with a band 704. This band is fastened around a horizontal bar 703 which is held in place with a worm screw 701. As illustrated in FIG. 25, the Adjustable Pedal Pad 750 can include multiple points of attachments for the bands 704.

FIG. 27 illustrates that the Adjustable Pedal Pad 750 may further include elongated orifices 955. These elongated orifices enable the band 704 to pass through the plate to wrap around a pedal for affixation or adjustment.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. An Improved Traction Pedal comprising:
a first surface, a second surface, and a plurality of traction studs;
the plurality of traction studs is disposed upon the first surface.

2. The Improved Traction Pedal of claim 1 further comprising a plurality of channels disposed upon the first surface.

3. A Pedal Cover comprising an elongate member, a plurality of rows of traction members, and at least one elastic member;
the elongate member comprises a top surface and a bottom surface;
the elastic member is disposed upon the bottom surface;
the plurality of rows of traction members is disposed upon the top surface.

4. An Adjustable Pedal Pad includes a wormscrew, a band, and a horizontal member; the wormscrew is in communication with the band and fastens the band to the horizontal member; the horizontal member.

5. The Adjustable Pedal Pad of claim 4 further including a plurality of bands and a plurality of horizontal bars.
